(19) United States
(12) Patent Application Publication
(10) Pub. No.: US 2025/0371262 A1
(43) Pub. Date: Dec. 4, 2025

(54) MULTILINGUAL SUPPORT USING LLM FOR DOCUMENT INFORMATION EXTRACTION

(71) Applicant: SAP SE, Walldorf (DE)

(72) Inventors: Sivakanth Jayaram, Kerala (IN); Vidhya K Pai, Bangalore (IN)

(73) Assignee: SAP SE, Walldorf (DE)

(21) Appl. No.: 18/679,297

(22) Filed: May 30, 2024

(51) Int. Cl. G06F 40/20; G06F 16/33

(52) U.S. Cl. CPC G06F 40/20; G06F 16/3337

(57) ABSTRACT

A document information extraction service can utilize an LLM to provide support for extracting information from documents in multiple languages. A trained first machine learning model can map data extracted from a first master document of a first document type in a first language. The mappings can be corrected via user input to obtain ground truth data for the master document. The ground truth data can be translated into a second language and optionally corrected to obtain translated ground truth data. An LLM can generate a training dataset of fake documents of the first document type that contain text in the second language based at least in part on the translated ground truth data. The trained first machine learning model can be trained further with the training dataset and deployed to extract data from documents of the first document type that contain text in the second language.

### FIELD

The field generally relates to extraction of content from digital documents using machine learning models.

### BACKGROUND

Machine learning models can be employed to facilitate extraction of information from documents such as invoices, payment advice documents, and purchase orders. In this context, a machine learning model is typically trained on documents including text in a select few languages. Accordingly, the machine learning model may be ineffective and error-prone when dealing with documents in unsupported languages (i.e., languages other than those on which they were trained).

A custom training option for the machine learning model is sometimes offered to customers to address such issues. This process requires customers to submit documents with varying templates and layouts tailored to their specific needs, which are then annotated using an annotation tool and saved as ground truth data. The annotated data is then utilized in a training pipeline for data augmentation to generate multiple synthetic documents with slight variations around the annotated regions. The resulting set of documents serves as the training dataset to develop the custom machine learning model. However, the entire process must be repeated separately for each language, there is no mechanism for incorporating customer feedback, and customers may be reluctant to provide relevant documents before witnessing acceptable accuracy from the generic model. As a result, using the custom training option to retrain a machine learning model for every possible language would be time-consuming, resource-intensive, and impractical.

Premium document information extraction services are also available which utilize specialized machine learning models which can compliantly handle private data. These specialized machine learning models can be trained with enterprise data provided by a customer in bulk, including documents in multiple languages. However, such services may be prohibitively expensive for most customers due to the high cost of the compliant machine learning models they incorporate.

Accordingly, there remains a need for less problematic and costly information extraction techniques for multilingual documents.

### BRIEF DESCRIPTION OF THE DRAWINGS

FIG. 1) is a block diagram of an example system implementing document information extraction with multilingual support.

FIG. 2) is a flowchart of an example method of implementing document information extraction with multilingual support.

FIG. 3) is a flowchart of an example method of generating a training dataset for document information extraction with multilingual support.

FIG. 4) is a block diagram showing an example inputs and outputs associated with a document information extraction service with LLM support for multiple languages.

FIG. 5) is a block diagram of an example system for generating mappings of extracted data to template fields via a trained ML model.

FIG. 6) is a block diagram of an example computing system in which described embodiments can be implemented.

FIG. 7) is a block diagram of an example cloud computing environment that can be used in conjunction with the technologies described herein.

### DETAILED DESCRIPTION

### Example 8)—Overview

Techniques are described herein for leveraging advanced machine learning techniques and Natural Language Processing (NLP) approaches to improve accuracy and enhance multilingual support of a document information extraction service.

During typical use of a document information extraction service, a user uploads a digital representation of a document (e.g., a PDF file) via a user interface and selects or inputs a template (e.g., schema) for the document. The document information extraction service then processes the document by extracting text from the document and analyzing the extracted text to attempt to map it to corresponding fields of the template. Towards this end, the document information extraction service can incorporate a machine learning model, referred to herein as a first machine learning (ML) model. The first ML model can be trained to generate mappings of portions of the extracted text to fields of the corresponding template.

For example, the first ML model can be trained using “ground truth” documents which include annotations around portions of text which correspond to respective fields of the template for the associated document type. The annotations, alternatively referred to as bounding boxes or field positions, can be specified by x- and y-coordinate values along with height and width values. The first ML model may be a state-of-the-art ML model which uses deep learning techniques, NLP, and transfer learning such that it is capable of learning and generalizing patterns across different languages.

While the typical process described above may be effective for processing documents in a few commonly used languages (e.g., one or two languages featured in the vast majority of documents in the training corpus for first ML model), the document information extraction service may have trouble accurately processing documents in other languages. The technologies described herein overcome these shortcomings without requiring an undue amount of effort by users of the document information extraction service. Instead, a user can input a single master document of a given document type to the document information extraction service, which can serve as a template for data augmentation. The document information service generates initial extraction results which can be corrected as needed via user input. The resulting corrected master document can then serve as a “ground truth” document for that document type, and can be translated into one or more selected languages, e.g., via a second ML model which incorporates a Large Language Models (LLM). The translated version(s) of the ground truth document can then be corrected via user input to obtain corresponding translated ground truth document(s).

The second ML model can then use the template and translated ground truth document(s) to generate a training dataset including, for each of the selected languages, a specified number of fake documents of the same document type as the master document. Each fake document can include slight adjustments to the text in one or more of the fields, and/or slight adjustments to the field positions of the one or more of the fields. The adjustments can be determined by the second ML model, independent of user input, to generate an appropriately varied training corpus for the first ML model.

In examples where the training dataset includes respective documents in multiple languages, the resulting multilingual training dataset can be used in a training process which leverages the collected multilingual fake documents to train the first ML model to extract information accurately from documents in various languages. The trained first ML model can be integrated into the document information extraction service and tested using a diverse set of documents representing different languages and document types to ensure desired accuracy and performance. The enhanced document information extraction service can then be deployed into production. The performance of the enhanced document information extraction service can be closely monitored and necessary adjustments made to ensure optimal accuracy and multilingual support.

The described technologies thus offer considerable improvements over conventional document information extraction techniques which tend to either require excessive customer effort to implement or prohibitively expensive specialized ML models.

### Example 9)—Example System Implementing Document Information Extraction with Multilingual Support

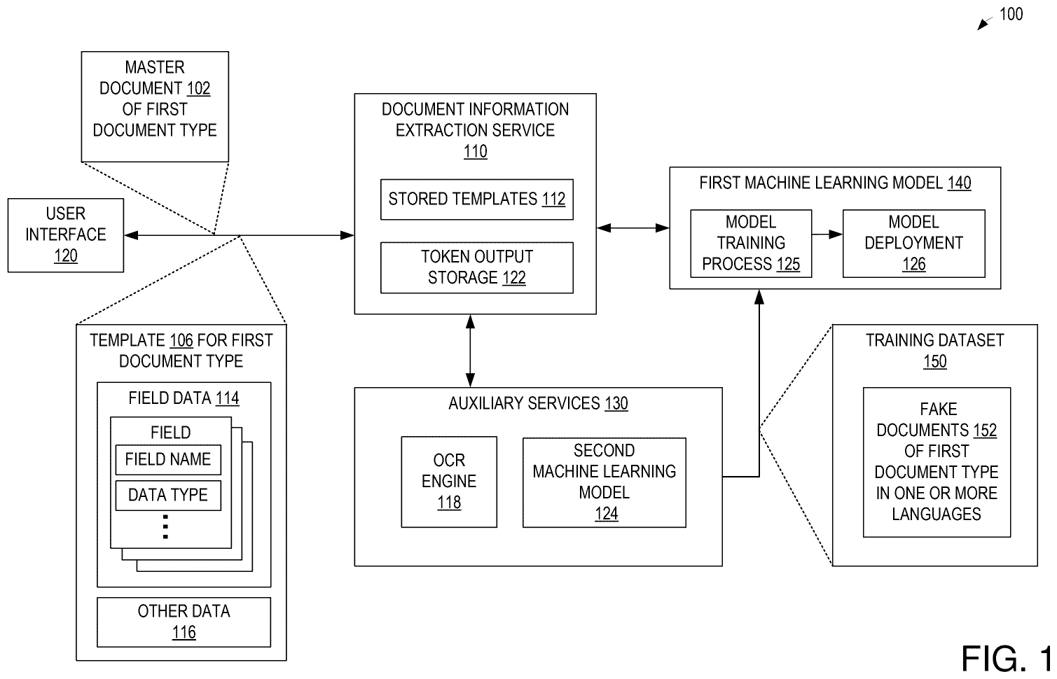

FIG. 1 is a block diagram of an example system 100 implementing document information extraction with multilingual support in accordance with examples of the present disclosure. In the example, the system 100 includes a document information extraction service 110, a user interface 120, auxiliary services 130, a first ML model 140, and a second ML model 124, among other elements. In accordance with the techniques described herein, the service 110 can incorporate ML and NLP approaches which enable a user to obtain support for extraction of documents of a particular document types in multiple languages.

In the example, a user first inputs (e.g., uploads) a digital representation of a master document 102 of a first document type to the service 110 via the user interface 120 (referred to herein as master document 102 for the sake of brevity). The master document 102 includes text in a first language. The digital representation of the master document 102 may include a Portable Document Format (PDF) file or another digital file format. While a single master document 102 is depicted for ease of explanation, a plurality of master documents 102 can be input to the service 110 (e.g., as part of a single upload or request, or in sequential uploads or requests). For example, a user may upload a master document for each of a plurality of different document types (e.g., a master document of the first document type containing text in the first language, a master document of a second document type containing text in the first language, etc.). Additionally or alternatively, a user may upload a master document for a given document type in each of a plurality of languages (e.g., a master document of the first document type in a first language, a master document of the first document type in a second language, etc.).

As used herein, the “document type” of a given document refers to a category to which the document belongs. Documents of a same document type may typically include the same or similar fields in the same or similar positions. Example document types include invoices, payment advice documents, and purchase orders. A business or other entity may have several core document types which are commonly used and processed by the entity.

As shown, a user can also input a template 106 for the first document type (i.e., the document type of master document 102) to the service 110, e.g., via user interface 120. Towards this end, the user can select a template from among a plurality of stored templates 112 output (e.g., displayed) via the user interface 120 (e.g., in list form or in a drop-down menu) or input a new template via the user interface 120. The template 106 can include predefined rules or settings for extraction of data from documents of the document type with which the template is associated. Towards this end, the template 106 can include field data 114 regarding the fields that may be present in a document of the document type associated with the template. The field data can include a field name and data type, among other data, for each of a plurality of fields. The field data may be organized such that header fields (e.g., fields that occur a single time within a document) are differentiated from line item fields (e.g., fields associated with columns of a data table, which may occur multiple times within a document depending on the number of rows in the data table). The template can also include other data 116 that is not specific to the fields, such as an indication of the document type associated with the template. If a pre-existing stored template is selected, the user can optionally modify the template via the user interface 120, e.g., by adding, deleting, or editing template data. If a new template is created, the user can manually input the template data via the user interface 120.

The master document 102 and template 106 may be input to the service 110 in the context of a request to train the service 110 to extract information from other documents of the first document type. In such an example, the request may be made via input to the user interface 120, or in another manner. Optionally, the request may include an indication of one or more languages to include in a training dataset generated based on the master document 102. For example, if the master document 102 contains text in a first language, the request can indicate that the training dataset should include documents in the first language alone, documents in the first language as well as in one or more other languages, or documents in one or more other languages but not in the first language. As described herein, the indication of which language(s) to include in the training dataset may be received at another stage instead of as part of the initial request (e.g., during a correction phase in which a user corrects initial mappings generated by the service 110).

In response to the request, the service 110 first processes the master document 102 by extracting text from the master document. In the example, the text extraction is performed by an Optical Character Recognition (OCR) engine 118, which is one of the auxiliary services 130. In other examples, another suitable character recognition system and/or algorithm may be used, such as intelligent character recognition (ICR).

The OCR engine 118 may be configured to perform one or more pre-processing operations to condition the data of the master document 102 for character recognition, including but not limited to analyzing the document to classify areas as including text (e.g., based on colors in the document, such as classifying light areas as non-text and dark areas as including text), enhancing clarity/image quality by performing one or more image processing operations (e.g., skewing/de-skewing, smoothing, artifact removal, etc. The OCR engine 118 may then execute one or more character recognition algorithms by analyzing the pre-processed document, including performing pattern matching and/or feature recognition to identify characters in the document. In some examples, the OCR engine 118 may perform post-processing operations including generating output relating to the results of the character recognition. The output of OCR engine 118 may include OCR tokens as well as bounding box coordinates for each OCR token. The bounding box coordinates for a given OCR token can include, for example, (x,y) coordinate pairs for each corner of the bounding box which indicate where on the document the bounding box corner is located.

The OCR tokens and associated bounding box coordinates output by the OCR engine 118 can be transmitted to the service 110 and stored in a token output storage 122. The service 110 can then transmit the OCR tokens and associated bounding box coordinates to the first ML model 140. The first ML model 140 may be a trained ML model which was trained during prior iterations of a model training process 125 to generate mappings of OCR tokens to corresponding fields of the template 106. The first ML model may be a state-of-the-art ML model which uses deep learning techniques, NLP, and transfer learning such that it is capable of learning and generalizing patterns across different languages.

One example ML model which may be used as the first ML model 140 is the Charmer extraction model. The Charmer model, which is based on a transformer architecture, operates directly on the OCR extraction results. The Charmer model exploits both the recognized text and the location of the text on the document to ensure precise classification of text and amounts.

As described further herein, the model training process 125 can include training the first ML model 140 using ground truth documents which include annotations around portions of text that correspond to respective fields of a template. The ground truth documents may take the form of JavaScript Object Notation (JSON) objects, for example.

In the example, the first ML model 140 can be deployed in a model deployment 126 to generate initial predictions of how the OCR tokens extracted from the master document 102 should be mapped to corresponding fields of the template 106. The resulting mappings output by the first ML model 140 are returned to the service 110, which in turn can output the mappings to the user, e.g., via user interface 120. The user can then optionally make one or more corrections to the mappings (e.g., via input to the user interface). The one or more corrections can include correction of text in one or more of the extracted fields, correction of a field position (e.g., field/bounding box coordinates) of one or more of the extracted fields, and/or annotation of one or more fields present in the template 106 which were not successfully mapped by the first ML model 140 for whatever reason.

In some examples, the user interface 120 can present the mappings in the form of an image which is similar to identical to the master document 102 except that it includes bounding boxes around the fields extracted from the master document 102 that have been mapped to corresponding fields of the template. In another region of the user interface 120 (e.g., a side bar or panel), a list of the mapped fields and value of the corresponding extracted text may be shown. The user interface 120 may be configured to allow a user to modify the content of this list of fields (e.g., by editing, adding, or deleting fields). The user interface 120 may also be configured to allow a user to draw new bounding boxes around text in the image of the master document with the mappings, and/or to adjust the bounding boxes output by the model (e.g., adjust their position within the document and/or their size). Alternatively, a user may correct the initial mappings in another manner.

After any corrections to the mappings have been made, the resulting annotated master document may be referred to as a ground truth document for the template 106 with respect to the original language of the master document 102. As noted above, in some examples, an indication of which language(s) to include in the training dataset may be received during this correction phase rather than during the initial request. In either case, if the only language to be included in the training dataset is the original language of the master document, the ground truth document maybe input to the second ML model 124 to serve as a basis for generation of fake documents 152 of the first document for the training dataset 150, as discussed further below.

Otherwise, if one or more other languages have been selected for inclusion in the training dataset, the ground truth document is translated into the selected language(s). The translation may be performed by the second ML model 124, which may incorporate an LLM capable of translating text into numerous different languages. Alternatively, the translation may be performed in a different manner. For example, auxiliary services 130 may include a separate dedicated service for translating text which can translate the text in the ground truth document into the selected language(s).

The translated data may then be presented to the user for further corrections, e.g., via user interface 120 in the form of an image of the master document with bounding boxes added. If multiple languages have been selected for the training dataset, a respective annotated master document image may be shown for each selected language (e.g., in separate tabs or sequentially). Due to individual idiosyncrasies of different languages, the translation of the text in the ground truth document(s) generated by the second ML model 124 or other service may either be incorrect or result in improperly sized or positioned bounding boxes. Accordingly, during this additional correction phase, a user can make one or more corrections to the content of the translated data or the associated bounding boxes to correct any such issues, thereby generating a translated ground truth document for the master document 102 for each selected language. The translated ground truth document(s) can then be input to the second ML model 124 to serve as a basis for generation of fake documents 152 of the first document type in the selected language(s) for the training dataset 150, as discussed further below. In particular, the second ML model 124 may generate the fake documents 152 by adjusting the positions and/or values of one or more fields of the translated ground truth document(s). Each of the fake documents 152 may be unique in some respect, such that no two fake documents 152 are identical.

As noted above, the second ML model 124 may be an LLM designed to understand and generate human language. Such models typically leverage deep learning techniques such as transformer-based architectures to process language with a very large number (e.g., billions) of parameters. Examples include the Generative Pre-trained Transformer (GPT) developed by OpenAI (e.g., ChatGPT), Bidirectional Encoder Representations from Transforms (BERT) by Google, A Robustly Optimized BERT Pretraining Approach developed by Facebook AI, Megatron-LM of NVIDIA, Text-To-Text Transfer Transformer (T5) model by Google, or the like. Pretrained models are available from a variety of sources. Optionally, the second ML model 124 can also be trained using information associated with the service 110 (e.g., JSON objects representing ground truth documents).

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, in addition to the training dataset 150, the model training process 125 can include a significant amount of other training data and test data so that outputs can be validated. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the training dataset 150, first ML model 140, and the like can be stored in one or more computer-readable storage media or computer-readable storage devices. The technologies described herein can be generic to the specifics of operating systems or hardware and can be applied in any variety of environments to take advantage of the described features.

### Example 10)—Example Method Implementing Document Information Extraction with Multilingual Support

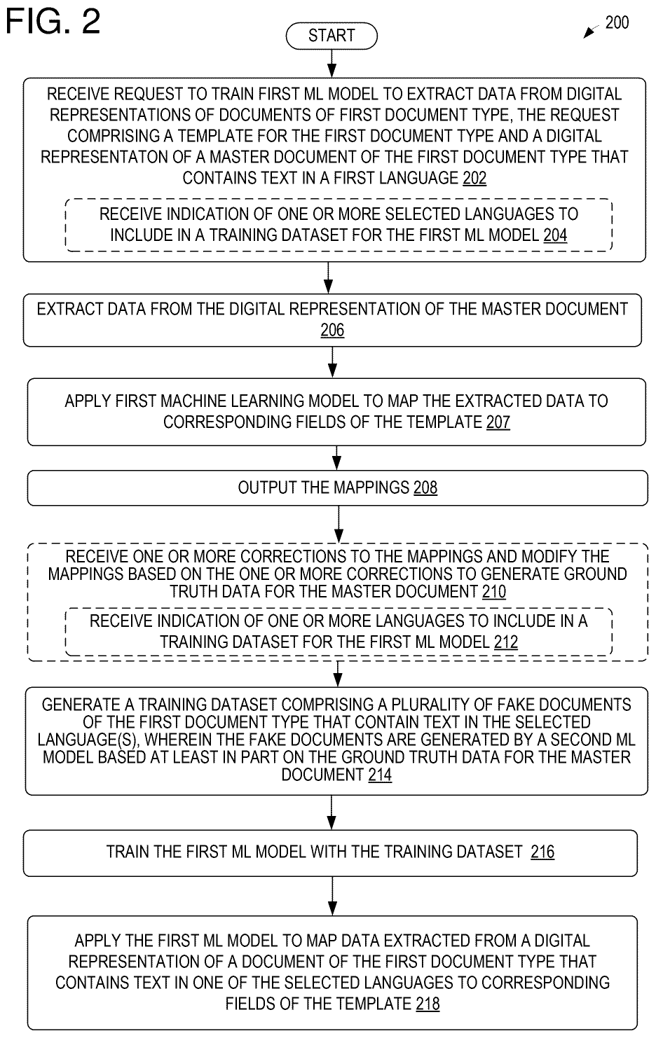

FIG. 2 is a flowchart of an example method 200 implementing document information extraction with multilingual support and can be performed, for example, by the system of FIG. 1. Method 200 pertains to an example in which the master document contains text in a first language and one or more languages (which may or may not include the first language) are selected for inclusion in the training dataset of a first ML model employed by a document information extraction service (e.g., service 110 of FIG. 1). For example, a user who needs to accurately extract information from documents of a first document type in selected languages which the document information extraction service has not yet been trained with may perform method 200 to generate a training dataset containing fake documents in the selected languages, train the first ML model with the training dataset, and then apply the first ML model to extract the information from the documents.

In the example, at 202, a request is received to train a first ML model to extract data from digital representations of documents of a first document type. The request includes a template for the first document type as well as a digital representation of a master document of the first document type that contains text in a first language. The request may be received via a user interface. For example, a user may upload the digital representation of the master document to a document information extraction service via a user interface. The user may generate a new template for the first document type in the user interface (e.g., by inputting information to the user interface regarding fields that may be present in documents of the first document type such as a field name, a data type, etc. for each field). Alternatively, the user may select from among a list of pre-existing templates, or edit a pre-existing template to obtain the template for the first document type.

Optionally, an indication of one or more languages to include in a training dataset for the first ML model is received at 204. The languages may be selected in a user interface of the document information extraction service (e.g., selected from a dropdown menu or other list). In other examples, the indication of which language(s) to include in the training dataset may be received at another stage of method 200 (e.g., during a correction phase). As described herein, after being trained with the training dataset comprising the documents in the selected language(s), the first ML model can be deployed in the document information extraction service to accurately extract fields from digital representations of documents of the corresponding document type. The process can be repeated for multiple different document types. For example, a customer of the document information extraction service may upload master documents for each document type commonly used by their entity. The customer can specify languages for which training is required (e.g., expected languages of documents of the specified type(s) that will be uploaded to the document extraction service for processing).

At 206, data is extracted from the digital representation of the master document. For example, an OCR engine acting as an auxiliary service to the document information extraction service (e.g., OCR engine 118 of FIG. 1) can extract the data in the form of OCR tokens.

At 207, the first ML model is applied to map the extracted data to corresponding fields of the template (i.e., the template for the first document type). For example, the document information extraction service can receive the extracted data from the OCR engine, optionally perform pre-processing on the extracted data, and then submit a prompt to the first ML model which includes the extracted data and the template. The first ML model can then be executed to map the extracted data to corresponding fields of the template and output the mappings to the document information extraction service.

At 208, the mappings are output. For example, the document information extraction service can present the mappings to a user via a user interface in the form of an image which resembles the original master document but with annotations (bounding boxes) added around the mappings. The user interface can also show a list of the template fields which have been mapped to extracted text (e.g., a table with a first column including template field names and a second column including corresponding extracted text for the respective field names, among other columns).

Optionally, at 210, one or more corrections to the mappings are received and the mappings are modified based on the one or more corrections to generate ground truth data for the master document. For example, a user may provide input via a user interface which modifies the extracted text, the bounding box position (e.g., x-coordinate or y-coordinate values), or the bounding box size (e.g., height and/or width) for one or more of the mappings such that all template fields present in the master document are properly annotated with bounding boxes. The resulting ground truth data may be formatted as a JSON object, among other options. The correction phase can also optionally include receiving an indication of one or more languages to include in the training dataset for the first ML model at 212 (e.g., instead of receiving such an indication at optional step 204).

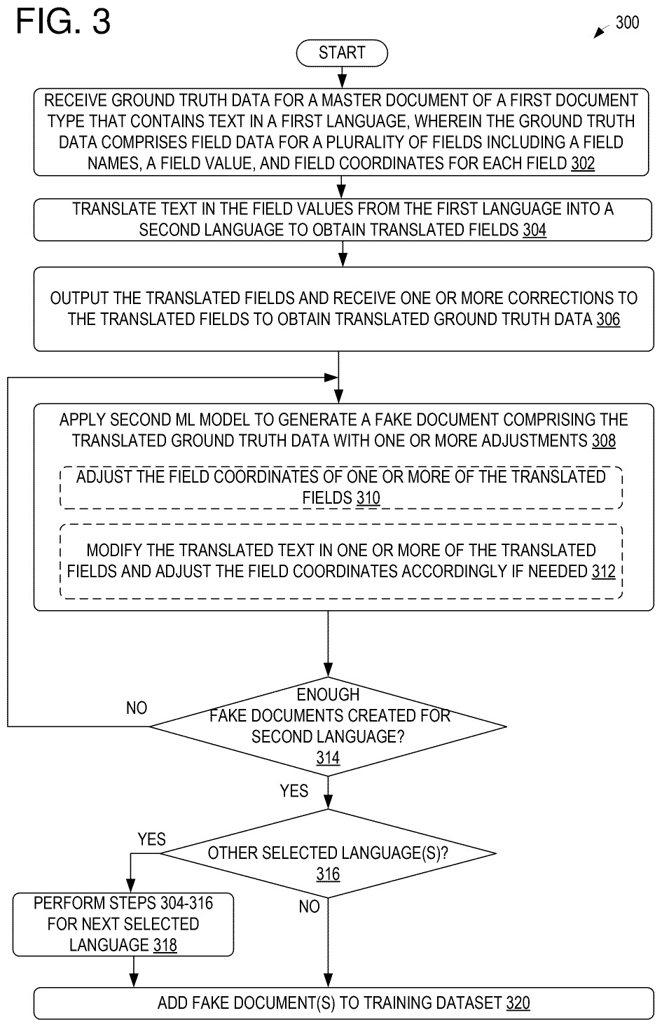

At 214, the method includes generating a training dataset comprising a plurality of fake documents of the first document type that contain text in the indicated language(s). As indicated, the fake documents are generated by a second ML model based at least in part on the ground truth data for the master document. Techniques for generating the training dataset are described in further detail herein with reference to FIG. 3. In examples where the selected language(s) include one or more languages that are different from the first language, generating the training dataset can include translating the text in the mappings into the selected language(s) and receiving one or more corrections to the translated versions of the mappings prior to generating the fake documents.

At 216, the first ML model is trained with the training dataset. At 218, following the training, the first ML model is applied to map data extracted from a digital representation of a document of the first document type that contains text in one of the selected languages to corresponding fields of the template.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a request can be described as sending a request depending on perspective.

### Example 11)—Example Method Generating a Training Dataset for Document Information Extraction with Multilingual Support

FIG. 3 is a flowchart of an example method 300 for generating a training dataset for document information extraction and can be performed, for example, by the system of FIG. 1 in conjunction with method 200 of FIG. 2. Method 300 pertains to an example in which the master document contains text in a first language and at least one other language is selected for inclusion in the training dataset of a first ML model employed by a document information extraction service (e.g., service 110 of FIG. 1).

In the example, at 302, ground truth data is received for a master document of a first document type. The ground truth data contains text in a first language (i.e., the original language of text in the master document). As described herein, the ground truth data may be a JSON object, or may take another form. The ground truth data comprises field data for a plurality of fields including a field name, field value, and field coordinates for each field. Each field may include one or more OCR tokens extracted from the master document which were mapped to respective field(s) the template for the first document type (e.g., via steps 202-210 of method 200).

The field coordinates for each field may include x- and y-coordinates that represent the position of the field on the master document. The field coordinates may also include a height and width of a bounding box for the field (e.g., a bounding box with the same position on the master document as the field). For example, the x-coordinate of a field may represent a horizontal distance between the bottom left corner of the document and the bottom left corner of the bounding box for the field. Similarly, the y-coordinate of a field may represent a vertical distance between the bottom left corner of the document and the bottom left corner of the bounding box for the field. The height and width values for a given bounding box are determined by the size of the associated field (e.g., for a field containing a string, the width value may be proportional to the length of string, and the height value may be proportional to the height of the characters in the string).

At 304, text in the field values is translated from the first language into a second language. As described herein, the translation may be performed by a second ML model which is an LLM (e.g., second ML model 124 of FIG. 1). The second language may be one of a plurality of languages selected for inclusion in a training dataset of a first ML model (e.g., one of the selected languages in the indication received at step 204 or 212 of FIG. 2). Alternatively, the second language may be the only language selected for inclusion in the training dataset.

At 306, the translated fields are output and one or more corrections to the translated fields are received to obtain translated ground truth data. As described herein, the one or more corrections may include corrections to the field values and/or field coordinates. The outputting of the translated fields and the receiving of the one or more corrections may be performed in the manner discussed above with reference to steps 210 and 212 of FIG. 2, or in another manner. For example, a user may provide input via a user interface which corrects the translated text of one or more translated fields and/or the position/size of one or more translated fields, thereby obtaining translated ground truth data in which the translated fields are properly annotated with bounding boxes and contain the correct text.

At 308, the second ML model is applied to generate a fake document comprising the translated ground truth data with one or more adjustments. The second ML model applied may be an LLM such as second ML model 124 of FIG. 1. The second ML model may generate the fake document by performing data augmentation on the translated ground truth data to adjust certain aspects of the translated ground truth data. It will be appreciated that the adjustments performed at step 308 are different from the corrections received at step 306. That is, the corrections involve receiving user input to correct the translated fields, whereas the adjustments are performed by the second ML model to generate fake documents which are slightly different from the translated master document.

As shown, the one or more adjustments can optionally include adjustment of the field coordinates of one or more of the translated fields at 310. For example, to introduce variety into the training dataset, the ML model may slightly vary the position a given translated field relative to the position of the corresponding field in the master document. Different variations may be used for different fake documents within the training dataset. For example, if the field coordinates of a given translated field are [x, y, h, w], one fake document may have the adjusted field coordinates [x+1, y, h, w] for that translated field, whereas another fake document may have the adjusted field coordinates [x+1, y−1, h, w] for that translated field, etc.

Further, the one or more adjustments can optionally include, at 312, modifying the translated text of one or more of the translated fields, and adjusting the field coordinates accordingly if needed. For example, the second ML model may be configured to determine which text may include private information and adjust that text to ensure compliance with data privacy regulations. As another example, the second ML model may introduce minor variations to the text within a translated field to help distinguish the resulting fake document from the translated version of the master document. These variations may change the amount of space the translated field occupies in the fake document, and thus, the second ML model may make corresponding adjustments to the field coordinates (and thus, the bounding box) for the translated field (e.g., to ensure the size and position are such that the bounding box still lines up with and encompasses the modified text).

After generating the fake document, the method proceeds to 314 to determine whether enough fake documents have been created for the second language. For example, the document information extraction service may specify a desired number of fake documents to generate for each selected language in a prompt to the ML model to generate a training dataset. Optionally, a user may input the desired number of fake documents for each language to a user interface during an earlier stage (e.g., in the initial request to generate the training dataset). If the answer at 314 is NO, indicating that the number of fake documents generated so far for the second language is less than the desired number of fake documents for the second language, the method returns to 308 to generate another fake document in the second language.

Otherwise, if the answer at 314 is YES indicating that enough fake documents have been generated for the second language (e.g., the number of fake documents generated for the second language is equal to the desired number), the method proceeds to 316 to determine whether other languages were selected for inclusion in the training dataset (e.g., by examining the initial prompt given to the ML model by the document information extraction service). If the answer at 316 is YES, the method proceeds to 318 in which steps 304-316 are performed for the next selected language; it will be appreciated that this may include repeating steps 312 and 314 numerous times depending on the number of fake documents desired for the next selected language.

Otherwise, if the answer at 316 is NO, the method proceeds to 320 to add any fake document(s) which have been generated to the training dataset (e.g., training dataset 150 of FIG. 1).

### Example 12)—Example Inputs and Outputs

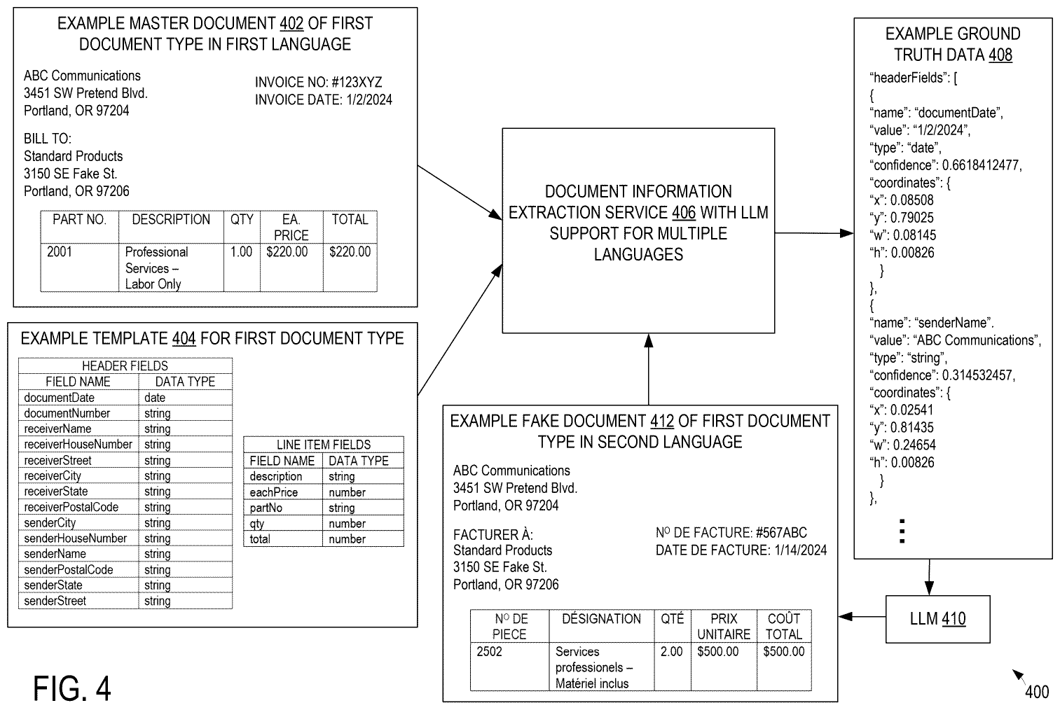

FIG. 4 is a block diagram showing an example inputs and outputs 400 associated with a document information extraction service with LLM support for multiple languages. In the example, an example master document 402 of a first document type in a first language (English in the example) and an example template 404 for the first document type are input to a document information extraction service 406 with LLM support for multiple languages. The service 406 generates mappings, which may be corrected (e.g., via user input) as described herein. After any corrections have been made, the mappings are input to an LLM 410 as ground truth data 408 for the master document. The LLM 410 generates an example fake document 412 of the first document type in a second language based at least in part on the ground truth data 408; this process can include translating the ground truth data and then receiving further corrections (e.g., via user input) to obtain translated ground truth data. The translated ground truth data is then adjusted by the LLM 410 to create numerous fake documents in the second language, such as fake document 412. While a single example fake document 412 is shown for ease of explanation, the LLM 410 may generate numerous (e.g., hundreds or thousands) of fake documents based on the ground truth data 408.

In the example, master document 402 is an invoice listing a sender name and address, bill recipient name and address, invoice number, invoice date, and a table with five line item columns and a single row (entry). The example template 404 for the first document type (i.e., invoice) includes a table of header fields and a table of line item fields. In the example, the tables for the header fields and line item fields each include two columns (field name and data type); in other examples, additional columns may be present. The template 404 may also include other data which is not depicted in the example, such as a description of the template, a document type associated with the template (e.g., invoice), a creation date of the template, and a status (e.g., DRAFT or ACTIVE).

The example ground truth data 408, which is formatted as a JSON object, specifies the name, value, type, confidence, and coordinates for each field mapping generated by the service 406. While only a few fields are depicted in the example, the ground truth data 408 would in practice include such details for each field extracted from the master document 402. The confidence value for each field indicates the degree of confidence in the mapping as estimated by the ML model that produced the mapping (e.g., the first ML model 140 of FIG. 1). In examples where a user provides corrections to the mappings and/or confirms the mappings are correct, the confidence scores for the mappings may be omitted or modified to 1 to indicate that the mappings have been confirmed to be accurate.

The example fake document 412 generated by the LLM 410 is similar to master document 402, except that the text (aside from text in the sender and recipient name and address fields) has been translated to a second language (French in the example). In addition, certain properties of the fields in the fake document 412 have been modified relative to the corresponding fields in the master document 402. In particular, modifications have been made in addition to the modification associated with translation of text from the first language to the second language). For example, the values of the documentNumber and documentDate header fields in the fake document 412 (i.e., the fields with the values “N° DE FACTURE: #567ABC” and “DATE DE FACTURE: Jan. 14, 2024”) have been slightly modified relative to the values of the corresponding documentNumber and documentDate header fields in the master document 402 (i.e., the fields in the master document 402 with the values “INVOICE NO: #123XYZ” and “INVOICE DATE: Jan. 2, 2024”) in addition to being translated. That is, in addition to the translation of the text in the values from English to French, the string “#123XYZ” has been modified to “#567ABC” and the date “Jan. 2, 2024” has been modified to “Jan. 14, 2024.”

Further, in the example, the positions of the documentNumber and documentDate fields in the fake document 412 have been shifted lower (i.e., their y-coordinate values have been reduced) relative to the positions of the documentNumber and documentDate fields in the master document 402. Moreover, as shown, the values of the partNo, description, qty, eachPrice, and total line item fields in fake document 412 have each been modified relative to the corresponding line item field in master document 402.

The nature and extent of the changes in the example fake document 412 are merely an example; other types and amounts of changes may be included in the fake documents generated by the LLM 410. As described herein, the LLM 410 may generate a large number of fake documents in each selected language when populating a training dataset. For example, the training dataset may include a plurality of sets of fake documents such that there is one set for each selected language. Within a given set of fake documents, each fake document may be unique in some way. The LLM 410 may perform data augmentation or other techniques on the master document 402 or on a translated version of the master document 402 to generate the fake documents.

As shown, the example fake document 412 (along with other fake documents in the training dataset generated by the LLM 410) serves as an input to the service 406. That is, as described herein, the fake documents in the training dataset serve as training inputs to an ML model employed by or incorporated in the service 406 (e.g., the first ML model 124 of FIG. 1). This training, among other training, enables the ML model to accurately extract data from documents of the first document type (e.g., invoices in the example) in the languages included in the training dataset (e.g., French in the example).

### Example 13)—Example System Training a Machine Learning Model for Multilingual Document Information Extraction

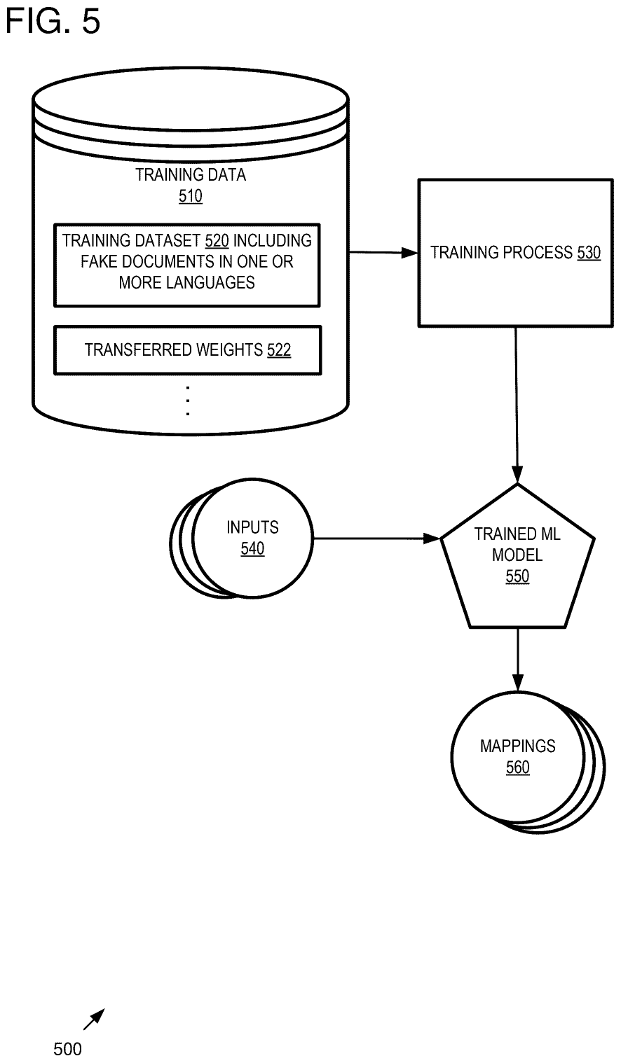

FIG. 5 is a block diagram showing an example system 500 training an ML model for multilingual document information extraction and can be implemented in any of the examples herein. The trained ML model can correspond to the first ML model 140 of FIG. 1, for example.

In the example, training data 510 is input to a training process 530 that produces a trained ML model 550. As shown, training data 510 can include a training dataset 520 including fake documents in one or more languages and transferred weights 522, among other data. The transferred weights 522 can include previously generated weights of the ML model 550 (e.g., weights generated during a prior training process of the ML model 550). The transferred weights 522 can provide a starting point for the training of the ML model 550, such that the ML model 550 does not need to be trained “from scratch.” In particular, a transfer learning process can be used in which knowledge from one task is used to improve learning in a new, related task. In particular, the learning from previous ML models can be leveraged and improved using new unseen data. For example, an ML model may be trained with data in 10 languages. To train that ML model to process data in an 11^{th} language, the ML model can be trained further using data in the 11^{th} language, thereby improving the ML model such that it can process data in all 11 languages.

The trained ML model 550 accepts one or more inputs 540 and generates one or more mappings 560. The inputs 540 can include data extracted from documents (e.g., OCR tokens extracted from a document by an OCR engine). The mappings 560 generated by the trained ML model 550 can accurately map data extracted from documents in multiple languages (e.g., the one or more languages of the fake documents in the training dataset 520) to template fields. As a result, the extracted data can be easily ingested for storage or processing in another software platform.

### Example 14)—Example ML Model

In any of the examples herein, an ML model (e.g., the first ML model 140 or the second ML model 124 of FIG. 1) can be used to generate outputs based on training data. In practice, any number of models can be used. Examples of acceptable models include one-class classifier, clustering technique, random decision tree, decision tree (e.g., binary decision tree), random decision forest, Apriori, association rule mining models, and the like. The model can be used to check whether the new data point is an outlier. Such models are stored in computer-readable media and are executable with input data to generate an automated output.

### Example 15)—Example Training Process

In any of the examples herein, training can proceed using a training process that trains the ML model using available training data. In practice, some of the data can be withheld as test data to be used during model validation.

Such a process typically involves feature selection and iterative application of the training data to a training process particular to the machine learning model. After training, the model can be validated with test data. An overall confidence score for the model can indicate how well the model is performing (e.g., whether it is generalizing well).

In practice, machine learning tasks and processes can be provided by machine learning functionality included in a platform in which the system operates. For example, in a database context, training data can be provided as input, and the embedded machine learning functionality can handle details regarding training.

### Example 16)—Example Confidence Score

In any of the examples herein, a trained ML model can output a confidence score with any outputs. For example, with reference to the first ML model described herein, such a confidence score can indicate how likely it would be that the mapping of a given portion of extracted text to a template field is accurate. The confidence score can be output alongside the mappings in a user interface.

The confidence score can also help with filtering. For example, the score can be used to filter out mappings with low confidence scores (e.g., failing under a specified low threshold or floor). For example, a portion of extracted text which has a mapping to a template field with a confidence score below a threshold may be excluded from the list of mappings. In some examples, confidence scores can be used to color code mappings (e.g., using green, yellow, red to indicate high, medium, or low confidence scores).

### Example 17)—Example Implementations

Any of the following can be implemented.

Clause 1. A computer-implemented method comprising: receiving a request to train a trained first machine learning model further to extract data from digital representations of documents of a first document type, the request comprising a template for the first document type and a digital representation of a master document of the first document type that contains text in a first language; extracting data from the digital representation of the master document; applying the trained first machine learning model to map the extracted data to corresponding fields of the template; outputting the mappings; receiving one or more corrections to the mappings; modifying the mappings based on the one or more corrections to generate ground truth data for the digital representation of the master document; generating a training dataset comprising a plurality of fake documents of the first document type that contain text in a second language, wherein the fake documents are generated by a second machine learning model based at least in part on the ground truth data; training the first machine learning model further with the training dataset; and applying the trained first machine learning model to map data extracted from a digital representation of a document of the first document type that contains text in the second language to corresponding fields of the template.

Clause 2. The method of Clause 1, wherein: the one or more corrections to the mappings are received via a user interface, and the one or more corrections to the mappings comprise at least one of: a modification of the extracted data; an adjustment of field coordinates; or an addition of a field specified in the template that was not extracted from the digital representation of the master document by the trained first machine learning model.

Clause 3. The method of Clause 2, wherein the ground truth data comprises field data for a plurality of fields, and wherein the field data for each field of the plurality of fields comprises a field name, a field value, and field coordinates.

Clause 4. The method of Clause 3, wherein generating the fake documents further comprises, for each field of the plurality of fields: translating text contained in the field from the first language into the second language to generate a corresponding translated field that contains the translated text.

Clause 5. The method of Clause 4, wherein generating the fake documents further comprises: outputting the translated fields; and receiving one or more corrections to the translated fields to obtain translated ground truth data, wherein the fake documents are generated by the second machine learning model based at least in part on the translated ground truth data.

Clause 6. The method of Clause 5, wherein: the one or more corrections to the translated fields are received via a user interface, and the one or more corrections to the translated fields comprise at least one of: a modification of the translated text in one or more of the translated fields; or an adjustment of field coordinates of one or more of the translated fields.

Clause 7. The method of Clause 5 or Clause 6, wherein generating the fake documents with the second machine learning model based at least in part on the translated ground truth data comprises, for each fake document: populating the fake document with the translated fields at their respective field coordinates; and modifying the translated text in one or more of the translated fields in the fake document and/or adjusting the field coordinates of one or more of the translated fields in the fake document.

Clause 8. The method of Clause 7, wherein adjusting the field coordinates of one or more of the translated fields in the fake document comprises at least one of: adjusting an x-coordinate value of one of the translated fields in the fake document; or adjusting a y-coordinate value of one of the translated fields in the fake document.

Clause 9. The method of any one of Clauses 1-8, further comprising at least one of: receiving an indication to use the second language for the training dataset as part of the request; or receiving an indication to use the second language for the training dataset along with the one or more corrections to the mappings.

Clause 10. The method of any one of Clauses 1-9, further comprising: storing the data extracted from the digital representation of the document of the first document type that contains the text in the second language in a database.

Clause 11. The method of any one of Clauses 1-10, wherein: the plurality of fake documents of the first document type that contain text in the second language is a first plurality of fake documents, the training dataset further comprises a second plurality of fake documents of the first document type that contain text in a third language, the second plurality of fake documents are generated by the second machine learning model based at least in part on the ground truth data, and the method further comprises at least one of: receiving an indication to use the second language and the third language for the training dataset as part of the request; or receiving an indication to use the second language and the third language for the training dataset along with the one or more corrections to the mappings.

Clause 12. The method of any one of Clauses 1-11, wherein the second machine learning model comprises a Large Language Model (LLM).

Clause 13. The method of any one of Clauses 1-12, wherein training the trained first machine learning model further comprises transferring previously generated weights of the trained first machine learning model.

Clause 14. A computing system comprising: at least one hardware processor; at least one memory coupled to the at least one hardware processor; a first machine learning model trained with digital representations of a plurality of documents of a first document type that contain text in a first language; a second machine learning model comprising a Large Language Model (LLM); and one or more non-transitory computer-readable media having stored therein computer-executable instructions that, when executed by the computing system, cause the computing system to perform: extracting data from a digital representation of a master document of the first document type that contains text in the first language; applying the trained first machine learning model to map the extracted data to corresponding fields of a template for the first document type; generating a training dataset comprising a plurality of fake documents of the first document type that contain text in a second language, wherein the fake documents are generated by the second machine learning model based at least in part on the mappings; and training the trained first machine learning model further with the training dataset.

Clause 15. The system of Clause 14, further comprising: a user interface receiving the template, the digital representation of the master document, and a request to train the trained first machine learning model further to extract data from digital representations of documents of the first document type that contain text in the second language.

Clause 16. The system of Clause 15, wherein: the user interface lists the mappings and receives one or more corrections to the mappings prior to generation of the training dataset by the second machine learning model.

Clause 17. The system of Clause 16, wherein the mappings are modified based on the one or more corrections to generate ground truth data for the digital representation of the master document, and wherein the fake documents are generated by the second machine learning model based at least in part on the ground truth data.

Clause 18. The system of Clause 17, wherein: the fake documents comprise translated fields generated by translating the text of respective corresponding fields of the ground truth data from the first language to the second language, one or more of the translated fields contain text that was modified before or after being translated from the first language into the second language, and one or more of the translated fields have field coordinates that are different from the field coordinates of the corresponding field of the ground truth data.

Clause 19. The system of any one of Clauses 15-18, further comprising computer-executable instructions that, when executed by the computing system, cause the computing system to perform: after training the trained first machine learning model further with the training dataset, applying the trained first machine learning model to extract data from a digital representation of a document of the first document type that contains text in the second language.

Clause 20. One or more non-transitory computer-readable media comprising computer-executable instructions that, when executed by a computing system, cause the computing system to perform operations comprising: receiving a request to train a first machine learning model to extract data from digital representations of documents of a first document type, the request comprising a template for the first document type, a digital representation of a master document of the first document type that contains text in a first language, and an indication of a plurality of selected languages, wherein each of the selected languages is different than the first language; extracting data from the digital representation of the master document; applying the trained first machine learning model to map the extracted data to corresponding fields of the template; outputting the mappings; receiving one or more corrections to the mappings; modifying the mappings based on the one or more corrections to generate ground truth data for the digital representation of the master document; translating the ground truth data into each of the selected languages to generate translated data; outputting the translated data; receiving one or more corrections to the translated data; modifying the translated data based on the one or more corrections to the translated data to generate translated ground truth data for the digital representation of the master document; generating a training dataset comprising, for each of the selected languages, a plurality of fake documents of the first document type that contain text in the selected language, wherein the fake documents are generated by a second machine learning model based at least in part on the translated ground truth data; training the trained first machine learning model further with the training dataset; and applying the trained first machine learning model to extract data from a digital representation of a document of the first document type that contains text in one of the selected languages.

### Example 18)—Example Advantages

A number of advantages can be achieved via the technologies described herein. For example, increased accuracy and reliability of document information extraction can lead to higher client satisfaction, resulting in improved customer retention and attracting new clients through positive referrals.

As another example, the expanded multilingual support provided by the technologies described herein can improve global market penetration. In particular, the expanded multilingual support can enable a document information extraction service to cater to a broader range of clients in various regions.

The technologies described herein can also provide advantages with respect to efficiency and cost savings. For example, with reduced model retraining time and resource requirements, a document information extraction service can efficiently add support for new languages, saving time and costs associated with training separate models for each language.

### Example 19)—Example Computing Systems

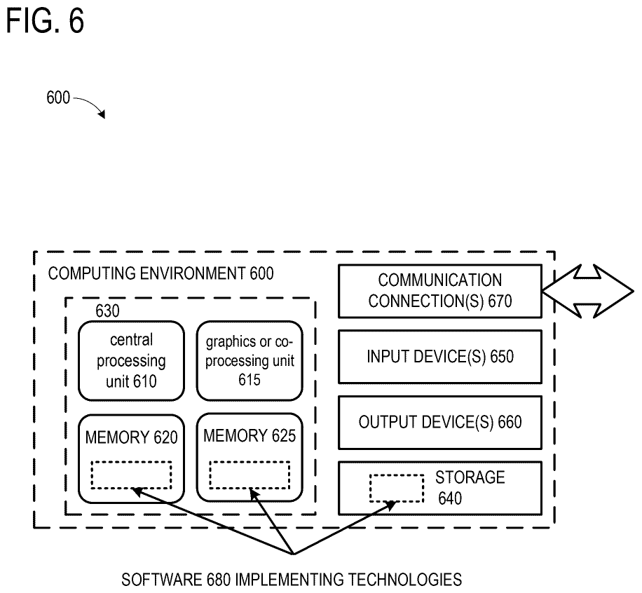

FIG. 6 depicts an example of a suitable computing system 600 in which the described innovations can be implemented. The computing system 600 is not intended to suggest any limitation as to scope of use or functionality of the present disclosure, as the innovations can be implemented in diverse computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 can be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615.

A computing system 600 can have additional features. For example, the computing system 600 includes storage 640, one or more input devices 650, one or more output devices 660, and one or more communication connections 670, including input devices, output devices, and communication connections for interacting with a user. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 can be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 can be an input device such as a keyboard, mouse, pen, or trackball, a voice input device, a scanning device, touch device (e.g., touchpad, display, or the like) or another device that provides input to the computing system 600. The output device(s) 660 can be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 20)—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 21)—Example Cloud Computing Environment

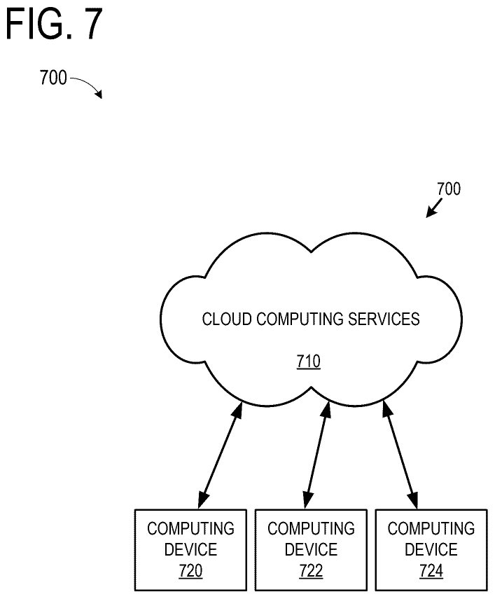

FIG. 7 depicts an example cloud computing environment 700 in which the described technologies can be implemented, including, e.g., the system 100 of FIG. 1 and other systems herein. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

In practice, cloud-based, on-premises-based, or hybrid scenarios can be supported.

### Example 22)—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 23)—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a request to train a trained first machine learning model further to extract data from digital representations of documents of a first document type, the request comprising a template for the first document type and a digital representation of a master document of the first document type that contains text in a first language;
extracting data from the digital representation of the master document;
applying the trained first machine learning model to map the extracted data to corresponding fields of the template;
outputting the mappings;
receiving one or more corrections to the mappings;
modifying the mappings based on the one or more corrections to generate ground truth data for the digital representation of the master document;
generating a training dataset comprising a plurality of fake documents of the first document type that contain text in a second language, wherein the fake documents are generated by a second machine learning model based at least in part on the ground truth data;
training the first machine learning model further with the training dataset; and
applying the trained first machine learning model to map data extracted from a digital representation of a document of the first document type that contains text in the second language to corresponding fields of the template.

2. The method of claim 1, wherein:
the one or more corrections to the mappings are received via a user interface, and
the one or more corrections to the mappings comprise at least one of:
a modification of the extracted data;
an adjustment of field coordinates; or
an addition of a field specified in the template that was not extracted from the digital representation of the master document by the trained first machine learning model.

3. The method of claim 2, wherein the ground truth data comprises field data for a plurality of fields, and wherein the field data for each field of the plurality of fields comprises a field name, a field value, and field coordinates.

4. The method of claim 3, wherein generating the fake documents further comprises, for each field of the plurality of fields:
translating text contained in the field from the first language into the second language to generate a corresponding translated field that contains the translated text.

5. The method of claim 4, wherein generating the fake documents further comprises:
outputting the translated fields; and
receiving one or more corrections to the translated fields to obtain translated ground truth data,
wherein the fake documents are generated by the second machine learning model based at least in part on the translated ground truth data.

6. The method of claim 5, wherein:
the one or more corrections to the translated fields are received via a user interface, and
the one or more corrections to the translated fields comprise at least one of:
a modification of the translated text in one or more of the translated fields; or
an adjustment of field coordinates of one or more of the translated fields.

7. The method of claim 5, wherein generating the fake documents with the second machine learning model based at least in part on the translated ground truth data comprises, for each fake document:
populating the fake document with the translated fields at their respective field coordinates; and
modifying the translated text in one or more of the translated fields in the fake document and/or adjusting the field coordinates of one or more of the translated fields in the fake document.

8. The method of claim 7, wherein adjusting the field coordinates of one or more of the translated fields in the fake document comprises at least one of:
adjusting an x-coordinate value of one of the translated fields in the fake document; or
adjusting a y-coordinate value of one of the translated fields in the fake document.

9. The method of claim 1, further comprising at least one of:
receiving an indication to use the second language for the training dataset as part of the request; or
receiving an indication to use the second language for the training dataset along with the one or more corrections to the mappings.

10. The method of claim 1, further comprising:
storing the data extracted from the digital representation of the document of the first document type that contains the text in the second language in a database.

11. The method of claim 1, wherein:
the plurality of fake documents of the first document type that contain text in the second language is a first plurality of fake documents,
the training dataset further comprises a second plurality of fake documents of the first document type that contain text in a third language,
the second plurality of fake documents are generated by the second machine learning model based at least in part on the ground truth data, and
the method further comprises at least one of:
receiving an indication to use the second language and the third language for the training dataset as part of the request; or
receiving an indication to use the second language and the third language for the training dataset along with the one or more corrections to the mappings.

12. The method of claim 1, wherein the second machine learning model comprises a Large Language Model (LLM).

13. The method of claim 1, wherein training the trained first machine learning model further comprises transferring previously generated weights of the trained first machine learning model.

14. A computing system comprising:
at least one hardware processor;
at least one memory coupled to the at least one hardware processor;
a first machine learning model trained with digital representations of a plurality of documents of a first document type that contain text in a first language;
a second machine learning model comprising a Large Language Model (LLM); and
one or more non-transitory computer-readable media having stored therein computer-executable instructions that, when executed by the computing system, cause the computing system to perform:
extracting data from a digital representation of a master document of the first document type that contains text in the first language;
applying the trained first machine learning model to map the extracted data to corresponding fields of a template for the first document type;
generating a training dataset comprising a plurality of fake documents of the first document type that contain text in a second language, wherein the fake documents are generated by the second machine learning model based at least in part on the mappings; and
training the trained first machine learning model further with the training dataset.

15. The system of claim 14, further comprising:
a user interface receiving the template, the digital representation of the master document, and a request to train the trained first machine learning model further to extract data from digital representations of documents of the first document type that contain text in the second language.

16. The system of claim 15, wherein:
the user interface lists the mappings and receives one or more corrections to the mappings prior to generation of the training dataset by the second machine learning model.

17. The system of claim 16, wherein the mappings are modified based on the one or more corrections to generate ground truth data for the digital representation of the master document, and wherein the fake documents are generated by the second machine learning model based at least in part on the ground truth data.

18. The system of claim 17, wherein:
the fake documents comprise translated fields generated by translating the text of respective corresponding fields of the ground truth data from the first language to the second language,
one or more of the translated fields contain text that was modified before or after being translated from the first language into the second language, and
one or more of the translated fields have field coordinates that are different from the field coordinates of the corresponding field of the ground truth data.

19. The system of claim 15, further comprising computer-executable instructions that, when executed by the computing system, cause the computing system to perform:
after training the trained first machine learning model further with the training dataset, applying the trained first machine learning model to extract data from a digital representation of a document of the first document type that contains text in the second language.

20. One or more non-transitory computer-readable media comprising computer-executable instructions that, when executed by a computing system, cause the computing system to perform operations comprising:
receiving a request to train a first machine learning model to extract data from digital representations of documents of a first document type, the request comprising a template for the first document type, a digital representation of a master document of the first document type that contains text in a first language, and an indication of a plurality of selected languages, wherein each of the selected languages is different than the first language;
extracting data from the digital representation of the master document;
applying the trained first machine learning model to map the extracted data to corresponding fields of the template;
outputting the mappings;
receiving one or more corrections to the mappings;
modifying the mappings based on the one or more corrections to generate ground truth data for the digital representation of the master document;
translating the ground truth data into each of the selected languages to generate translated data;
outputting the translated data;
receiving one or more corrections to the translated data;
modifying the translated data based on the one or more corrections to the translated data to generate translated ground truth data for the digital representation of the master document;
generating a training dataset comprising, for each of the selected languages, a plurality of fake documents of the first document type that contain text in the selected language, wherein the fake documents are generated by a second machine learning model based at least in part on the translated ground truth data;
training the trained first machine learning model further with the training dataset; and
applying the trained first machine learning model to extract data from a digital representation of a document of the first document type that contains text in one of the selected languages.
